(19) United States
(12) Patent Application Publication
(10) Pub. No.: US 2026/0307893 A1
(43) Pub. Date: Oct. 8, 2026

(54) TRANSPORT AND STORAGE SYSTEM FOR METAL COILS

(71) Applicant: VOESTALPINE STAHL GMBH, Linz (AT)

(72) Inventors: Martin KRASCHOWETZ, St. Georgen an der Gusen (AT); Martin PROMBERGER, Eggendorf im Traunkreis (AT); Georg REISINGER, Linz (AT)

(21) Appl. No.: 19/485,037

(22) PCT Filed: May 24, 2024
(86) PCT No.: PCT/EP2024/064429

§ 371 Date: Nov. 17, 2025

(30) Foreign Application Priority Data
May 24, 2023 (DE) 10 2023 113 576.7

(51) Int. Cl. B65D 90/00; B65D 85/66

(52) U.S. Cl. CPC B65D 90/004; B65D 85/66; B65D 2590/0058

(57) ABSTRACT

The invention relates to a transport and storage system for metal coils for receiving, in particular horizontal, cylindrical metal sheet coils, wherein at least one module (8, 9) is present, which is formed from a stack of corrugated cardboard, wherein the liners of the corrugated cardboard layers are oriented so that they extend substantially perpendicularly to a receiving surface (11) of the module (8, 9), wherein the transport and storage system has at least one base module (8) and at least one insert module (9) for insertion into the base module (8), wherein the insert module (9) has contact surfaces (10) for contacting the base module (8) and receiving surfaces (11) for receiving the metal coil.

The invention relates to a transport system for metal coils, in particular sheet steel coils.

Steel or other metal sheets are usually produced in that a slab made of the corresponding metal material, which is usually produced by melting and casting the steel material into the slab mold, is then rolled into a flat sheet steel strip or flat sheet metal strip. For this purpose, a corresponding metal slab passes through a rolling mill with corresponding rolling stands, with the thickness of the slab and later of the sheet decreasing from one stand to the next.

Using sheet steel as an example, this takes place in such a way that the slab, which usually weighs between 20 and 40 tons, is first heated in a pusher furnace to ensure that the slab is at a very high temperature that permits deformation. This slab is then first pre-rolled in a reversing roughing stand and, after reaching a target thickness and while still in the hot and glowing state, is conducted through a hot rolling line with a large number of hot rolling stands.

The end result is a hot strip and the thickness of the hot strip can range from a few millimeters to a few centimeters.

In order to produce a thin sheet from this hot strip, this hot strip is then rolled to the target sheet thickness in a cold rolling mill; for thin sheet that is to be used in the automotive industry, for example, the target sheet thickness is between 0.3 and 1 mm.

Since the width of these strips is regulated, the change in thickness from the slab to the hot strip to the cold strip makes the continuous sheet metal strip very long so that at the end of the rolling process, it is wound into so-called bundles or coils in both the hot strip process and the cold strip process.

The thin sheet or cold-rolled strip can also be provided with coatings after the cold rolling; metallic coatings are usually applied using the hot-dip process, for example a hot-dip galvanized layer.

For this purpose, these strips are unwound again, conducted through a galvanizing unit, and then wound again.

At most, the weight of such steel coils can equal that of the slab, but multiple coils can also be produced from a single slab so that the weight of the wound coil is usually between 4 and 40 tons. The weight of the coil may also increase slightly after a potential coating process, in particular a galvanizing process.

In order to move such coils, specialized vehicles are used, which can reach with a mandrel through a longitudinal opening corresponding to the longitudinal axis of the cylindrical coil, lift the coil, and move it. Such a vehicle is known, for example, from WO2016044891. Such coils should therefore preferably be transported in a horizontal position since it is then possible to reach into the coil eye. In a vertical position, the coil eye would point upward and it would no longer be possible to perform such an action in the longitudinal axis of the coil.

During all stacking or transporting procedures, it is naturally important not to subject the steel coils to pressure at isolated points since this would deform the sheet metal or damage the metallic coating layer; as is known, such indentations can extend several layers into the interior of the coil. These regions therefore can no longer be classified as defect-free and in some cases must even be discarded.

Such coils can of course be transported by trucks, trains, or ships.

Due to the sensitivity of the coil surface or sheet metal surface on the one hand and on the other, the fact that these coils are very heavy and constitute a considerable potential hazard when they are put in motion, such coils must be transported in a way that is reliably safe, but also gentle. When transporting heavy loads, especially one-piece loads such as steel coils, particular attention must be paid to load distribution, i.e. point loading or excessive axle loads during transport can be problematic. Particular attention must be paid to this with regard to national and international freight transport regulations.

A load at isolated points is also disadvantageous in storage at the steel mill or at the customer's premises and should be avoided.

A number of approaches have already been tried for transporting coils, especially in containers.

It should be noted here that due to the considerable weight of steel coils, only one or at most two steel coils can ever be loaded per truck or per container and any movement of the steel coils must be prevented, especially in the case of sea-going containers, since a moving steel coil weighing 23 tons will permanently destroy any outer packaging.

EP 1 907 301 B1 discloses a stowage system in which metal coils are stored in polystyrene blocks, wherein the polystyrene block for receiving the steel coil corresponds to a recess that corresponds to the radius of the coil and receives a partial circumference of the coil, which is large enough that the steel coil cannot easily escape from this block. If multiple coils are present, a cuboid block is inserted as a spacer between the coils and between the first and last coil and a corresponding container wall. This is intended to secure the coils in the longitudinal and transverse directions.

IN 20 20 23 00 82 61 A1 discloses a comparable stowage system, which is, however, made of different materials, such as pressed paper.

AT 522 138 A1 discloses flexibly adapted support beams that extend through the polystyrene blocks as well as a central, continuous polystyrene support beam.

DE 10 2017 113 499 A1 discloses a transport protection for coils that is made of wood, wherein a thin layer of cardboard can be present between the wood and the coil to prevent indentations in the coil.

JP2022018234 A2 discloses a plug-in system made of cardboard that can be used to transport cylindrical bodies. This system cannot be used for steel coils, though, because the dimensions of the plug-in connections are too thin.

EP 1880899 A1 discloses a stowage system made of corrugated cardboard in which a simple, partially cylindrical support is formed from upright pieces of laminated corrugated cardboard, which are additionally provided with plastic layers. Such an arrangement is unable either to support steel coils or to hold them in place.

WO2009139643 A1 discloses a comparable system in which a corrugated cardboard is supported by an upright supporting structure that is likewise made of corrugated cardboard, with these upright supporting structures being connected by means of sleeves. Such an embodiment is unable to fulfill its function; it is far too unstable.

JP2019081614A2 also discloses a plug-in system comprised of plate-like elements for sur-rounding a coil with a ribbed structure made of corrugated cardboard. First of all, such a system is not particularly stable and also, it is almost impossible to use such a system in confined spaces.

The problem of the invention is to create a transport and storage system for metal coils, which reliably stores heavy metal coils, makes them transportable, and can be disposed of easily and without problems. In particular, such a transport and storage system should make the metal coils stackable for storage and make them transportable by container or truck.

The problem is solved with a transport and storage system having the features of claim 1.

Advantageous modifications are disclosed in the dependent claims thereof.

The known systems in the prior art have some significant disadvantages: for one thing, the price of polystyrene blocks has risen significantly, for another, there are huge problems with disposal, or the polystyrene blocks have to be sent back, which adds to the costs in international shipping.

Particularly in the case of sustainably produced steel such as greentec steel®, it is also undesirable for sustainably produced steel to be delivered using non-sustainably produced transport systems.

It is also necessary for steel coils to be stored in a gentle, protected way and for them to be secured against rolling away, not only during transport but also at the storage location such as in the steel mill or at the customer's premises. A stackable storage system is particularly advantageous, i.e. a coil that is correspondingly wrapped in corrugated cardboard can have another correspondingly wrapped coil stored on top of it.

Surprisingly, it has been discovered that the above-mentioned requirements can be met with a transport and storage system made of corrugated cardboard.

In this case, however, the corrugated cardboard is not, as is usually the case, employed with its broad side against the goods to be transported; instead, the orientation of the corrugated cardboard is basically selected so that the end surfaces, which extend transversely to the corrugation, are oriented toward the goods to be transported and/or stored-in this case, the coil.

Corrugated cardboard is a cellulose product made from the raw material paper. At least one smooth paper web and one fluted paper web are glued to each other to produce corrugated cardboard, it being both possible and common for there to be up to 7 of these. The decisive characteristic of a corrugated cardboard is the fluting. It gives the lightweight paper its strength through an intrinsically known increase in the so-called surface moment of inertia. In this connection, a distinction can be drawn between different flute types and flute combinations, which are more suitable depending on the requirements and the region in which they are used.

Corrugated cardboard is one of the most common packaging materials and is primarily used for transport packaging, i.e. folding cartons or telescoping boxes, for example. The advantage of corrugated cardboard is that it is light and stable. Thanks to the base material of paper, corrugated cardboard packaging can be easily and completely recycled, but can also very often be reused. It is now quite common to use so-called heavy-duty corrugated cardboard for cardboard packaging, which is affixed to a Euro pallet, for example, and can also hold heavy items such as car parts. With clever folding patterns, such heavy-duty corrugated cardboard boxes can be folded down to a fraction of their volume, returned, and reused multiple times.

The corrugated structure is the most important and decisive feature of corrugated cardboard and gives the latter its particular stability and strength. For example, the structure is such that there is a flat inner liner on which a first corrugated web is positioned, with an intermediate liner being positioned on the first corrugated web, followed by a second corrugated web, and after this, an outer liner. Such an arrangement results in a so-called double-flute structure, wherein the first corrugated web can have a different wave frequency than the second corrugated web, which further promotes stability. The advantage of the corrugation is, on the one hand, the considerable increase in stability, which three paper webs lying on top of each other would not have, by contrast with an arrangement having an inner liner, a corrugated web, and an outer liner.

As explained above, this is due to the increase in the surface moment of inertia. Since the corrugated web is glued to both the inner liner and outer liner in the region of the flute peaks, the corrugated web also cannot be displaced. The cavities formed in this way ensure that corrugated cardboard is very light in relation to its volume and also has an insulating effect. In the single-flute corrugated cardboard described above, the outer and inner liners are glued to the corrugated web. For multi-flute corrugated cardboards, an intermediate liner and an additional corrugated web are added.

Corrugated cardboard is produced in so-called corrugators. Paper webs are fed through cor-rugating rollers and embossed with the aid of heat, moisture, and pressure. The shape of the embossed flute resembles a sine wave in cross-section. The flute types differ by their flute pitch (t) and flute height (h). The distance between two flute valleys is the flute pitch (t). The distance between the flute valley and the flute peak is the flute height (h). In the single-flute range, the C flute (medium flute), B flute (fine flute), and E flute (ultra-fine flute or microflute) are among the most commonly used flute types. As mentioned above, the different flute types can also be different in the subsequent flutes of a multi-flute composite.

To give a corrugated cardboard greater stability, several layers are glued to one another. Typical flute combinations in the double-flute range are, for example, BC flute, EB flute, or EE flute. In triple-flute corrugated cardboard, ACA, BAA, EBC, or BBC are the flute combinations that are frequently used.

For the purposes of the invention, though, any other combination of the known flute types is also possible and intended.

Not only the flute combination but also the paper quality for the liner paper and the flute can be selected as a function of the load.

So-called kraft liner or test liner can be used for the liner paper, while so-called semichemical pulp or bogus paper can be used for the fluting.

Single-flute or double-flute corrugated cardboard is used for shipping lighter shipments. Triple-flute corrugated cardboard offers appropriate protection for heavy and sensitive goods and can be used as an alternative to wooden systems. Exports in particular are subject to a wide range of climatic conditions, which triple-flute corrugated cardboard usually withstands with no trouble. Surprisingly, it has turned out that in combination with adhesives, single-flute and especially double-flute corrugated cardboard can prove to be the most suitable solution for the application in terms of the combination of dead weight and load-bearing capacity. Single-flute or double-flute corrugated cardboard can therefore be advantageously used as a transport and storage material in the application according to the invention.

The quality of corrugated cardboard is checked using various testing systems. The DIN 55468 standard was developed based on the standards of the German Association of the Corrugated Board Industry. If corrugated cardboard solutions are to comply with the standard, the bursting strength, puncture resistance, and edge crush resistance, among other things, must comply with certain values.

In the transport and storage system according to the invention, corrugated cardboard is thus used in the manner according to the invention, wherein the corrugated web is built in perpendicular to the outer liner or inner liner or intermediate liner and in addition, is preferably built in in such a way that the fluting also extends transversely. In technical jargon, this is referred to as vertical flute corrugated cardboard. This is unusual in that normally, corrugated web is built in in such a way that the load rests on the inner or outer liner.

In addition, the invention provides for the corrugated cardboard to be combined to form corrugated cardboard stacks so that an at least double-flute composite or stack is formed. However, a triple-flute, in particular more than ten-flute, and even more preferably more than twenty-flute composite or stack can also be used. Surprisingly, however, it has turned out that a single-flute or double-flute corrugated cardboard composite can already have sufficiently high stability with a comparatively low dead weight.

According to the invention, the corrugated cardboard is also bonded with adhesives that are not susceptible to fungal attack and, in particular, with adhesives that do not provide a breeding ground for conventional fungi or other microbes, such as glues, in particular white glues, spray adhesives, or also hot-melt adhesives.

In addition, the paper forming the corrugated cardboard can also be embodied to be fungus-inhibiting.

Preferably, an adhesive is also used that does not dissolve when exposed to moisture. A 24-hour water bath test can be carried out for this purpose. In particular, the corrugated cardboard is glued or bonded in a waterproof manner.

In particular, the paper itself can also be embodied as moisture-resistant and in particular, can have a moisture-resistant bonding. This can also be omitted if a high-quality kraft liner is used.

A transport and storage system according to the invention for receiving metal coils, in particular horizontally oriented ones, is modular in design and has at least one base module and at least one insert module, which is adapted to and fitted into the insertion region thereof, which are each embodied as a stack of corrugated cardboard.

According to the invention, the base module is embodied as U-shaped in cross-section, with a bottom wall and two side walls extending orthogonal therefrom. This embodiment can be composed of one piece so that the corners between the bottom wall and the side walls are rounded due to the bending of the corrugated cardboard layers.

The base module can have a length orthogonal to the cross-section that corresponds to the length of a coil that is to be received or that is shorter or longer than it.

If the base module is shorter, then several base modules can receive the coil, which can facilitate handling in certain cases.

In this instance, it is also possible for the base module to have the basic dimensions of a standard pallet, i.e. for it to be 800×1200 mm in size. This allows the base module to also be secured to a standard pallet and to be lifted and moved with it. This is advantageous particularly when transporting by truck since a coil that is packed in this way on a standard pallet can be easily and efficiently loaded onto and unloaded from the respective transport means. But advantageously, the standard pallet can also be omitted and the base module can serve as a base pallet, which can be transported, loaded, and unloaded by means of a forklift, for example.

In order to contain a coil on all sides, the arrangement composed of a base module and at least one insert module can conversely be placed onto the coil from above, wherein the base modules rest against one another with end surfaces of their side walls or are spaced apart from one another.

The insert module can be embodied as triangular in cross-section, with a flat receiving surface. In this case, two insert modules are used per base module.

It is also possible, however, for only a single insert module to be used that conversely has a region that is cut out so that it is triangular in cross-section, forming two receiving surfaces, wherein the opening of the triangular cut-out faces upward and is wider than the diameter of a coil.

When two insert modules are used, they are embodied as triangles in cross-section and in particular as regular right triangles in which the contact surfaces define a right angle with each other. In the event that the corners of the base module 8 are rounded, then this must naturally also be true for the angle between the contact surfaces.

When there are two insert modules, they are positioned opposite each other, wherein one leg rests with a contact surface against a bottom wall of the base module and a vertical leg rests with a contact surface against a side wall of the base module.

In another embodiment, there is only one insert module, wherein the at least one insert module has at least one receiving surface, which is concave and in particular, is embodied as a cylinder circumference segment. This embodiment is ideally adapted to a coil shape. Alternatively, the receiving surface can have an elliptical shape, which is almost equivalent to a cylinder circumference segment, which is adapted to the respective outer diameter of the coil by means of fitting pieces such as rubber mats. By means of this, this embodiment can be ideally adapted to a coil shape and nevertheless, can be flexibly adapted to various outer diameters of the coil.

In both variants, a circular or elliptical cut-out, in particular a cut-out that corresponds to the radius of the coil to be received, is cut out from a single cuboid corrugated cardboard block.

If an elliptical cut-out is used, this can for example deviate by at most 100 mm, in particular at most 50 mm, from the outer radius of the coil.

Such a monolithic block is particularly also suitable for a particularly gentle storage of coils between processing steps or prior to transport at the steel mill or before further processing at the customer's premises.

This block can be designed for transport by train or truck so that the coil on the block can be efficiently loaded onto and unloaded from the transport means. In addition, it can also be correspondingly stored on this block at the steel mill or at the customer's premises.

Such a monolithic block, however, can also be used for container transport and then, for example, has a width that corresponds to the width of the container, a height that corresponds to the desired height of the region of the coil that is received by the partially cylindrical opening in the block, in addition to a distance that should be present between the bottom of the base module and the coil.

If several coils are stowed in a container, then spacer elements made of corrugated cardboard can also be positioned in relation to the container end walls, e.g. the rear wall, extending over a full or partial width of the container. Such elements can naturally also be positioned between the coils and thus also in the longitudinal direction between the first, second, third, and fourth modules. This also secures the coils in the container in the longitudinal direction.

The resulting recess opens toward the top.

The depth of the cut-out is dimensioned in such a way that up to at least a quarter, in particular a third, and especially more than a third and up to half of the diameter or more than half of the diameter of a coil is supported in the cut-out.

In addition, it is also possible for a monolithic corrugated cardboard block not to extend across the entire width of the container and in this respect for the second modules described above to be used to establish the distance from the wall.

In order to improve handling, the corrugated cardboard blocks can also be positioned in a subdivided way in relation to the length of a coil so that over the entire length of a coil, there are, for example, three corresponding first modules per side, i.e. a total of six modules, positioned opposite from one another. Between these first modules, fifth modules can be provided, which space these first modules longitudinally apart from one another and fix them in position.

Tests have shown that a corrugated cardboard that is loaded in the above-described manner, namely on the end edges extending at right angles to the corrugation, exhibits such a high level of stability that it is not necessary to support the metal coil over its entire surface.

In one embodiment, the modules can be provided with chamber-like, hollow regions in order to further reduce the weight. Such hollow regions are preferably punched-out regions that are located underneath the actual receiving surface. There can also be multiple hollow regions that form a partition-like or truss-like supporting structure between them. This can further improve handling. In particular, this reduces the weight and thus takes occupational safety into account.

Since condensation often occurs in containers, it is advantageous if the corrugated cardboard is made of papers that can optionally be embodied as moisture-resistant. The same applies to the adhesive, which is preferably also waterproof.

To further protect the elements, a single layer of silicone paper or similar moisture-repellent material can be provided between the receiving surfaces of the modules on the one hand and the coil on the other.

One advantage of the invention is that, surprisingly, corrugated cardboard, when loaded on its end surfaces contrary to its conventional use, has a surprisingly high stability, which is sufficient for use in a transport and storage system. Another advantage is that a sustainable stowage system is used, which can be reused multiple times if necessary, but can also be easily recycled at the end of its use cycle and can therefore be used endlessly. Even thermal recycling is possible since it involves a renewable raw material. Thanks to the modular design composed of adapted insert modules that are always the same for the respective coils, it is possible to minimize the production cost and achieve a greater variability.

The invention thus relates in particular to a transport and storage system for metal coils for receiving cylindrical sheet metal coils, in particular horizontally oriented ones, wherein at least one module is present, which is formed from a stack of corrugated cardboard, wherein the liners of the corrugated cardboard layers are oriented so that they extend substantially perpendicularly to a receiving surface of the module, wherein the transport and storage system has at least one base module and at least one insert module for insertion into the base module, wherein the insert module has contact surfaces for contacting the base module and receiving surfaces for receiving the metal coil.

In one modification, the insert module engages in the base module in a tongue-and-groove-like or plug-like manner.

In one modification, the height of the engaging region corresponds to more than 10%, in particular more than 20%, of the height of the base module. This advantageously ensures a particularly good bonding and introduction of forces.

In one modification, the height of the engaging region corresponds to less than 25%, in particular less than 20%, preferably less than 10%, of the height of the base module. This advantageously permits the modules to be simply and safely installed and removed for reuse without risking damage to the modules or the engaging region.

In one modification, the width of the engaging region corresponds to between 20% and 60% of the width of the base module.

In one modification, the depth of the engaging region corresponds to between 20% and 60% of the depth of the base module.

In one modification, the base module is made of a different corrugated cardboard quality, in particular a higher corrugated cardboard quality, than the insert module. It is thus possible to ensure that the base module has a longer service life and can be reused more frequently.

In one modification, the insert modules are embodied extending over a total length of more than 30%, in particular more than 40%, particularly preferably more than 50% of the coil width.

In one modification, the corrugated cardboard for forming the modules, or the stacks of corrugated cardboard, or the corrugated cardboard and the stacks formed therefrom are glued together in a waterproof manner.

In one modification, the material for the liners of the corrugated cardboard is a kraft liner and/or the corrugated webs are made of semichemical pulp or bogus paper.

In one modification, the liners and the corrugated layers are glued in a moisture-resistant and in particular waterproof manner.

In one modification, the corrugated cardboard layers are combined to form corrugated cardboard stacks that are glued together over their entire surface by means of the liners so that an at least double-flute, in particular more than triple-flute, preferably more than ten-flute, and even more preferably more than twenty-flute composite or stack is formed.

In one modification, the paper material forming the corrugated cardboard is equipped or bonded in a way that makes it moisture-resistant and/or fungicidal.

In one modification, the base module is embodied as U-shaped in cross-section, with a bottom wall and two side walls extending orthogonal therefrom.

In one modification, orthogonal to the cross-section, the base module has a length that corresponds to the length of a coil to be received or that is shorter or longer than it, or the base module has the basic dimensions of a standard pallet, i.e. is 800×1200 mm in size.

In one modification, on the underside in the bottom wall, the base module has openings for being engaged by forklifts or for a tongue-and-groove system to allow the base modules to be stacked on top of one another by means of their bottom walls.

In one modification, in order to contain a coil on all sides, the arrangement composed of a base module and at least one insert module is conversely placed onto the coil from above, wherein the base modules rest against one another with end surfaces of their side walls or are spaced apart from one another by 1 mm to 100 mm, in particular 5 mm to 25 mm.

In one modification, the base module has tongues and grooves on end surfaces of the side walls in order for it and an identically embodied base module to reciprocally fit into each other when their end surfaces rest against each other.

In one modification, the insert module is embodied as triangular in cross-section, with a flat receiving surface or conversely has a cut out region that is triangular in cross-section, forming two receiving surfaces, wherein the opening of the triangular cut-out faces upward and is wider than the diameter of a coil.

In one modification, at least two insert modules are provided, which are embodied as triangles in cross-section and in particular as regular right triangles in which the triangle legs define a right angle with each other.

In one modification, two insert modules are positioned opposite each other, wherein one leg rests with its contact surface on a bottom wall of the base module and a vertical leg rests with its contact surface against a side wall of the base module.

In one modification, in order to fill a distance between the base module and a transport container wall, modules are positioned between the base module and a transport container wall. In one modification, at least one insert module is provided, wherein the at least one insert module has at least one receiving surface that is concave or elliptically curved and in particular, is embodied as a cylinder circumference segment.

In one modification, the insert module has a width that corresponds to the inner width between the side walls of the base module so that the base module can receive the insert module with a positive fit.

In one modification, the size of the triangular insert modules or the radius of the concave receiving surface is adapted to the diameter of a coil that is to be received or the elliptical curvature of the receiving surface is adapted so that it deviates from the outer radius of the coil by at most 100 mm, in particular by at most of 50 mm.

In one modification, at least one cylindrical element extends away from a receiving surface, toward a contact surface, and through the insert module or through the insert module and the base module.

In one modification, the at least one cylindrical element is mounted in a bore with a positive fit or interference fit.

In one modification, the bore extends radially outward in relation to the radius of a coil to be received or extends outward at an angle to the radial direction.

In one modification, the cylindrical element is embodied as a solid cylinder or hollow cylinder. In one modification, the cylindrical element is made of metal, plastic, or cardboard.

In one modification, the cylindrical element extends through the bore and terminates with a positive fit with the respective surfaces of the insert module, or the cylindrical element is recessed by 1 mm to 100 mm, in particular 2 to 50 mm, preferably 2 to 20 mm, in the region of the receiving surface and is spaced apart by means of a cavity.

In one modification, the cylindrical element contacts a bottom wall of a container or a load-bearing beam of an entire transport arrangement.

In one modification, several bores and several cylindrical elements distributed around the circumference or along a receiving surface extend through the insert module or through the insert module and the base module.

The invention will be explained by way of example in conjunction with the drawings. In the drawings:

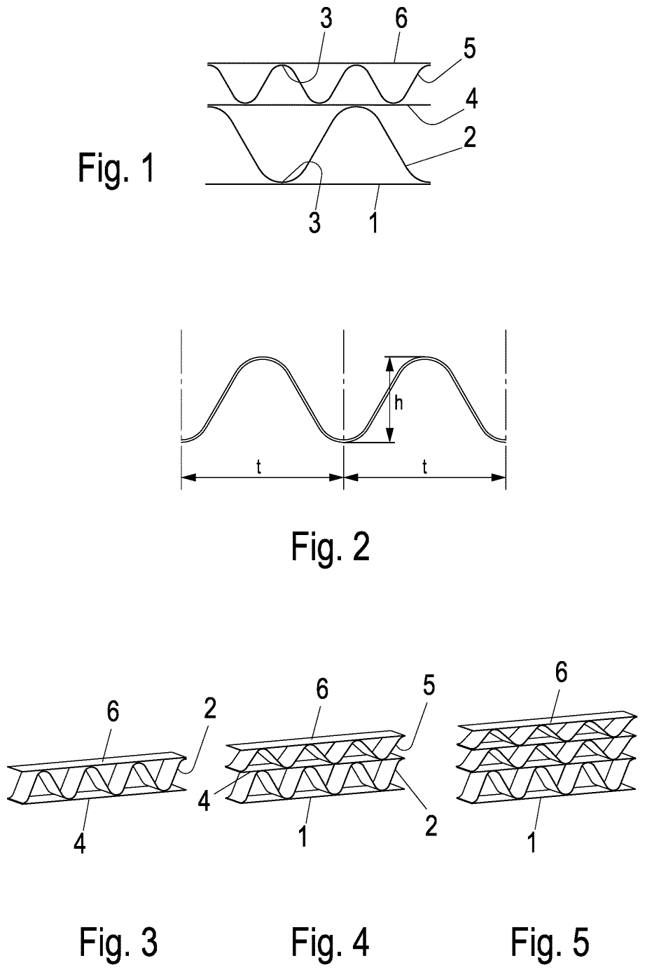

FIG. 1: shows the basic structure of a double-flute corrugated cardboard;

FIG. 2: shows a flute with the dimensions;

FIG. 3: shows a single-flute corrugated cardboard;

FIG. 4: shows a double-flute corrugated cardboard;

FIG. 5: shows a triple-flute corrugated cardboard;

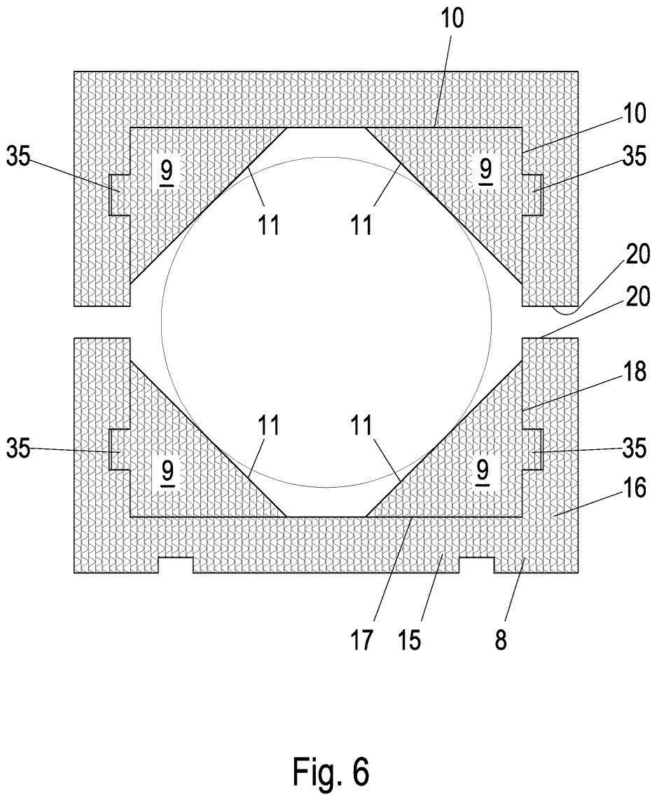

FIG. 6: shows a first embodiment of the transport and storage system;

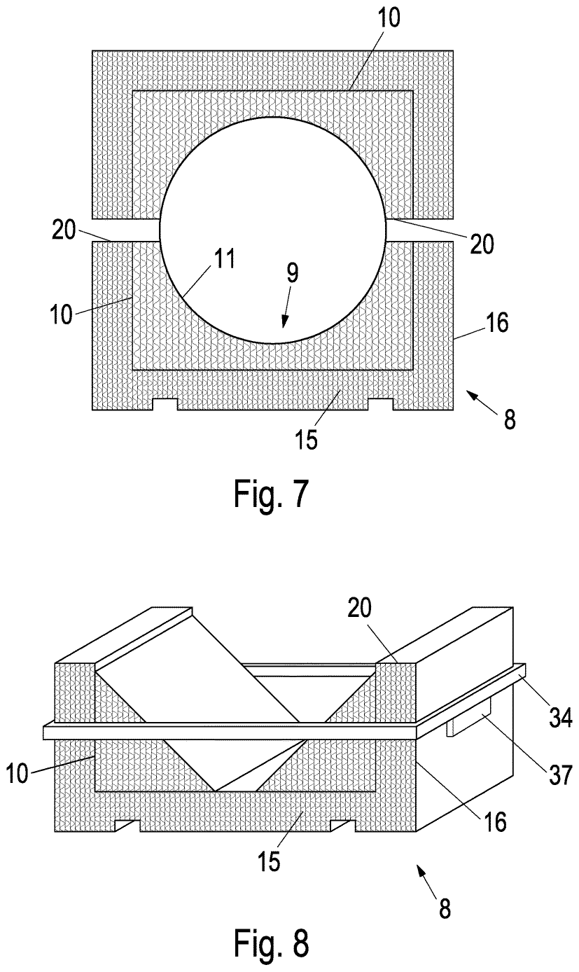

FIG. 7: shows a second embodiment of the transport and storage system;

FIG. 8 shows an isometric depiction of an embodiment of the transport and storage system;

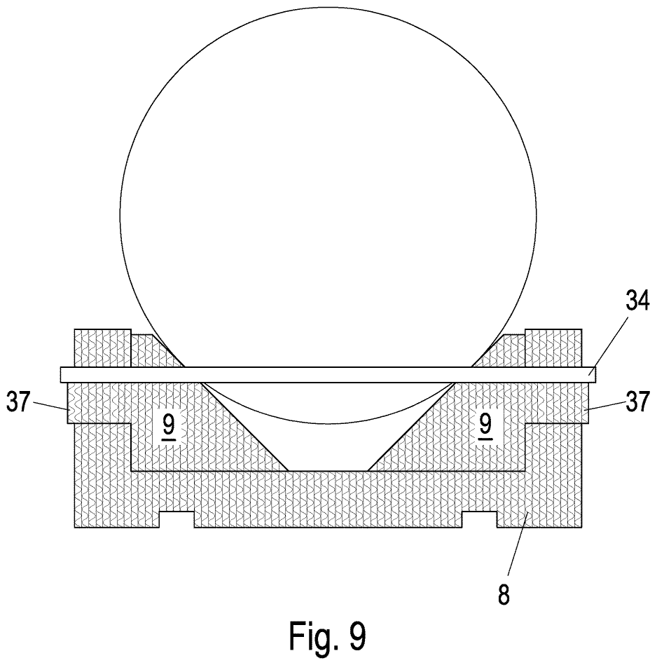

FIG. 9 shows a front view and side view of an embodiment of the transport and storage system;

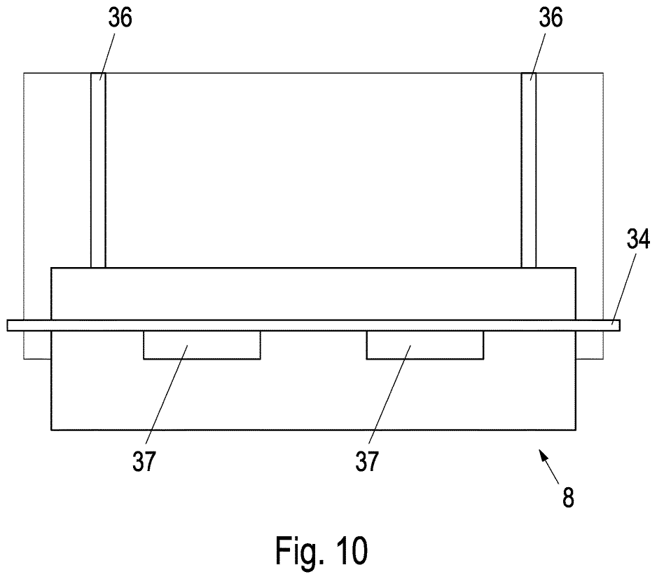

FIG. 10 shows a side view of an embodiment of the transport and storage system;

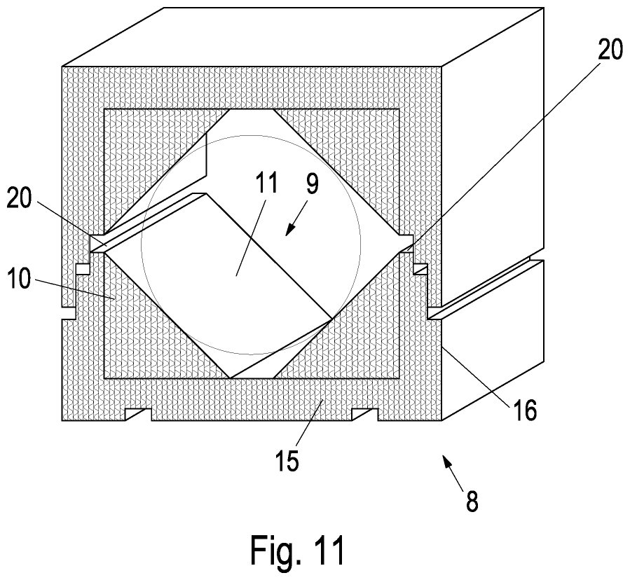

FIG. 11 shows another embodiment of the transport and storage system.

FIG. 1 shows the basic structure of a double-flute corrugated cardboard. An inner liner 1, which is a flat paper layer, is followed by a first corrugated web 2, which rests with its flute peaks 3 against the inner liner 1 and is glued to it.

This corrugated web 2 has an intermediate liner 4, which is also a flat paper surface, resting against it and this intermediate liner 4 has another corrugated web 5 resting against it, which has a lower height and whose distance (t) between flute peaks 3 is also smaller. An outer liner 6, which is also a flat paper web, is glued to this corrugated web 5, resting against the flute peaks 3.

The papers used for this are known thick, tear-resistant papers, in particular so-called kraft liner paper, at least on the outsides for additional stability and moisture protection.

The individual sheets, such as the inner liner 1, the intermediate liner 4, and the outer liner 6, are correspondingly bonded to the corrugated webs 2, 5 in a waterproof manner.

According to the invention, it has turned out that pure cornstarch adhesives are unsuitable for the use of corrugated cardboard according to the invention since they are unable to withstand climatic conditions, in particular moisture, and can also be a breeding ground for fungi. If resin is added to the corn starch adhesive, this can greatly increase the resistance to moisture and fungal attack.

FIG. 2 shows a corrugated web with a view of the end surface in which the flute pitch (t) and the flute height (h) are indicated. The distance between two flute peaks is the flute pitch (t) and the distance between a flute valley and the next flute peak is the flute height (h).

In principle, single-flute, double-flute, or multi-flute corrugated cardboards can be used since according to the invention, stacks of several layers of corrugated cardboard are created any-way, which are glued together over their entire surface.

Typical flute combinations in the double-flute range according to the standard are BC flute, EB flute, or EE flute. In triple-flute corrugated cardboards, ACA, BAA, EBC, or BBC flute combinations are common. However, depending on requirements, any desired combination of the known flute types K flute, A flute, C flute, B flute, D flute, E flute, F flute, G flute, and N flute is possible.

Kraft liner is used as the liner material. Semichemical pulp or bogus paper is selected for the corrugation, with various combinations being possible here.

Depending on the climatic conditions, these papers can also be equipped in a way that makes them moisture-resistant, biocidal, or fungicidal. In particular, they can be embodied to be fungicidal.

FIGS. 3, 4, and 5 basically show the single-flute, double-flute, and triple-flute structures once again.

According to the invention, block-like modules are formed from stacks of corrugated cardboard. Thus, combinations of triple-flute, double-flute and single-flute corrugated cardboard are possible and desired and in particular, can be used to establish the exact width of the individual modules. In this case, the corresponding single-flute, double-flute, or triple-flute cardboards are placed with their outer liners resting against one another and are glued to one another so that, in addition to the usual corrugated cardboard bonding in the single-flute, double-flute, or triple-flute structure, additional corrugated cardboards are glued to one another over their entire surface.

The adhesives used for corrugated cardboard production can be used in this case as well and particularly in this connection, correspondingly climate-resistant, moisture-resistant, and heat-resistant adhesives can be used. In particular, mixtures of cornstarch, glue with synthetic resins, and starch adhesives can be used for wet-strength bonding of the individual webs.

FIG. 6 Shows a first embodiment of the transport and storage system.

A transport and storage system according to the invention for receiving metal coils, in particular horizontally oriented cylindrical sheet metal coils, has at least one base module 8 and an insert module 9 that is fitted into it, which are each formed from a stack of corrugated cardboard, wherein the liners 1, 4, 6 of the corrugated cardboard layers 2, 5 are oriented so that they extend substantially perpendicularly to a receiving surface 11 of the module 9 and parallel to the force direction.

In this case, the insert module 9 has contact surfaces 10 for contacting the base module 8 and receiving surface 11 for receiving the metal coil. As is shown in the figure, the insert module 9 can also have one or more engaging regions 35, which are suitable for connecting to and inserting into the base module 8. This can ensure both increased stability of the module combination and optimal force transmission of the coil weight.

The corrugated cardboard for forming the modules 8, 9, or the stacks of corrugated cardboard, or the corrugated cardboard and the stacks formed therefrom are glued together in a waterproof manner.

The material for the liners 1, 4, 6 of the corrugated cardboard is a kraft liner and/or the corrugated webs 2, 5 are made of semichemical pulp or bogus paper.

The liners 1, 4, 6 and the corrugated layers are preferably glued in a moisture-resistant and in particular waterproof manner.

According to the invention, the base module 8 is embodied as U-shaped in cross-section, with a bottom wall 15 and two side walls 16 extending orthogonal therefrom. This embodiment can be composed of one piece so that the corners between the bottom wall 15 and the side walls 16 are rounded due to the bending of the corrugated cardboard layers.

The base module 8 can have a length orthogonal to the cross-section that corresponds to the length of a coil that is to be received or that is shorter or longer than it.

By means of this, a coil can be completely received and the end edges of the coil can in particular be protected if the base module 8 protrudes beyond the coil.

If the base module 8 is shorter, then several base modules 8 can receive the coil, which can facilitate the handling in some circumstances.

In this instance, it is also possible for the base module 8 to have the basic dimensions of a standard pallet, i.e. for it to be 800×1200 mm in size. This allows the base module 8 to also be secured to a standard pallet and to be lifted and moved with it. This can advantageously facilitate the process of loading onto and unloading from transport means such as trucks and/or trains.

On the underside in the bottom wall 15, the base module 8 can itself have openings, as shown in FIGS. 6 to 10, for being engaged by the forks of a forklift. This allows the transport and storage system to also be used without a standard pallet.

In addition, these openings can be part of a tongue-and-groove system to allow the base modules 8 to be stacked on top of one another by means of their bottom walls 15.

In order to contain a coil on all sides, the arrangement composed of a base module 8 and at least one insert module 9 can conversely be placed onto the coil from above (FIG. 6), wherein the base modules 8 rest against one another with end surfaces 20 of their side walls 16 or are spaced apart from one another.

It is clear that several such arrangements can be stacked on top of one another. In this case, the above-mentioned tongue-and-groove system can be used, which prevents lateral slippage. Alternatively, several layers can also be stacked on top of one another in the center of the modules to form a two-or three-layer stack.

In addition, the base module 8 can have tongues and grooves on end surfaces 20 of the side walls 16 in order for it and an identically embodied base module 8 to reciprocally fit into each other when their end surfaces 20 rest against each other. This also prevents lateral slippage when end surfaces 20 stacked on top of one another and produces a good positive fit.

As shown in FIG. 6, the insert module 9 can be embodied as triangular in cross-section, with a flat receiving surface 11. In this case, as shown in FIG. 6, two insert modules 9 per base module 8 are used.

It is also possible, however, for only a single insert module 9 to be used that conversely has a cut out region that is triangular in cross-section, forming two receiving surfaces 11, wherein the opening of the triangular cut-out faces upward and is wider than the diameter of a coil.

When two insert modules 9 are used, they are embodied as triangles in cross-section and in particular as regular right triangles in which the contact surfaces 10 define a right angle with each other. In the event that the corners of the base module 8 are rounded, then this must naturally also be true for the angle between the contact surfaces 10.

As shown in FIG. 6, two insert modules 9 are positioned opposite each other, wherein one leg 17 rests with its contact surface 10 against a bottom wall 15 of the base module 8 and a vertical leg 18 rests with its contact surface 10 against a side wall 16 of the base module 8.

In order to fill a distance between the base module 8 and a transport container wall, additional modules (not shown) are positioned between the base module 8 and a transport container wall. This is helpful, for example, if the base module is adapted to the width of a transport trolley or truck trailer and is narrower than a shipping container or vice versa.

In another embodiment, at least one insert module 9 is provided (FIG. 7), wherein the at least one insert module 9 has at least one receiving surface 11, which is concave and in particular, is embodied as a cylinder circumference segment. As a result, this embodiment is ideally adapted to a coil shape. The receiving surface 11 can, however, also be elliptically shaped and can correspond only approximately to the coil shape.

In this instance, the insert module 9 has a width that corresponds to the inner width between the side walls 16 of the base module 8 so that the base module 8 can receive the insert module 9 with a positive fit.

Basically, it is useful for the size of the triangular insert modules 9 or the radius of the concave receiving surface 11 to be adapted to the diameter of a coil that is to be received. The modular design with a base module 8 and an insert module 9 is ideal for this since the base modules 8 are always the same and it is possible for only the insert modules 9 to be adapted.

FIG. 8 shows an isometric depiction of the base modules 8 and insert modules 9 according to FIG. 6. In this case, only the lower part is shown since this can basically also be used without a cover. FIG. 8 shows a connecting element 34, which connects the insert modules 9 to the base module 8. In this case, this connecting element 34 rests against abutment surfaces 37 on both sides of the base module 8.

FIG. 9 shows a frontal sectional view of one embodiment. In this case, the engaging regions 35 extend through the base module 8 and constitute the abutment surface 37 on the outside the base module 8. The connecting element 34 rests against this abutment surface 37.

FIG. 10 shows a side view of this embodiment. Naturally, it is also possible for the engaging regions 35 not to extend through the base module 8, but for separate abutment surfaces 37 to be formed onto the outside of the base module 8. FIG. 10 shows the binding strap 36 that is wrapped around the coil. It is also possible for the binding strap to be wrapped around the entire transport and storage device, securing it so that it can be transported as a unit.

Another embodiment is shown in which complementary-shaped base modules 8 on the one hand are used as a bottom element and on the other hand, complementary-shaped base modules 8 are used, which are placed onto the coil (FIG. 11). This ensures safe transport and storage. In addition, the transport device or even just the coil can be wrapped with a standard binding strap 36.

In order to embody the insert modules 9 in a more stable fashion and/or to connect them to the base modules 8 in a more long-lasting way, at least one cylindrical element (not shown) can extend away from a receiving surface 11, toward a contact surface 10, and through the insert module 9 or through the insert module 9 and the base module 8.

The at least one cylindrical element can be mounted in a bore with a positive fit or interference fit, wherein the bore extends radially outward in relation to the radius of a coil to be received or extends outward at an angle to the radial direction.

The cylindrical element can be embodied as a solid cylinder or hollow cylinder and can be made of metal, plastic, or cardboard. Making it out of cardboard ensures a uniformity of the material.

The cylindrical element can extend through the bore and terminates with a positive fit with the respective surfaces of the insert module 9, or the cylindrical element can be recessed somewhat in the region of the receiving surface 11 and be spaced apart from the receiving surface 11 by means of a cavity. In this case, it can contact a bottom wall of the transport container, a hall floor, or a load-bearing beam of an entire transport arrangement.

Naturally, several bores and several cylindrical elements can also be distributed around the circumference or along a receiving surface 11 and can extend through the insert module 9 or through the insert module 9 and the base module 8.

Particularly when the element is made of cardboard or is embodied as a cardboard tube, there is the advantage that the transport concept is made of a single material that is also recyclable.

In addition, it can be advantageous and enhance the stability if a connecting element 34 en-compasses the base module 8 and the insert modules 9. This connecting element 34 can be made of wood, corrugated cardboard, or other materials. Preferably, the connecting element 34 can be composed of the same recyclable material as the base module 8. To improve the connection of such an element 34, abutment surfaces 37 can be provided on the outer walls of the base module 8 to allow the connecting element 34 to be placed against the abutment surfaces 37 and also to make the installation and removal as simple as possible.

Naturally, an adaptation of the engaging regions can be carried out in such a way that they extend from the base module 8 and engage in the insert module 9. Alternatively or in addition, naturally several engaging regions per module 8, 9 can be provided.

The binding strap 36 can wrap around only the respective coil, but it can also extend around the base module 8, the insert modules 9, and the coil. In particular if it extends around the connecting element 34, it can easily and efficiently ensure a safe transport of a coil that is packaged with a base module 8 in this way.

In order to achieve even greater protection from the effects of moisture in more extreme climatic conditions, especially in tropical regions, the end surfaces of the corrugated cardboard that are open due to the corresponding cuts can also be covered with kraft liner paper or, in extreme cases, with silicone paper or similar water-repellent layers.

One advantage of the invention is that a sustainable raw material is used to produce load-bearing transport and storage systems that have a high load-bearing capacity and are gentle to the stored goods.

1. A transport and storage system for metal coils for receiving cylindrical sheet metal coils, in particular horizontally oriented ones, wherein at least one module (8, 9) is present, which is formed from a stack of corrugated cardboard, wherein the liners (1, 4, 6) of the corrugated cardboard layers are oriented so that they extend substantially perpendicularly to a receiving surface (11) of the module (8, 9), characterized in that the transport and storage system has at least one base module (8) and at least one insert module (9) for insertion into the base module (8), wherein the insert module (9) has contact surfaces (10) for contacting the base module (8) and receiving surfaces (11) for receiving the metal coil.

2. The transport and storage system according to claim 1, characterized in that the insert module (9) engages in the base module (8) in a tongue-and-groove-like or plug-like manner.

3. The transport and storage system according to claim 2, characterized in that the height of the engaging region (35) corresponds to more than 10%, in particular more than 20%, of the height of the base module (8) and/or that the height of the engaging region (35) corresponds to less than 25%, in particular less than 20%, preferably less than 10%, of the height of the base module (8) and/or the width of the engaging region (35) corresponds to between 20% and 60% of the width of the base module (8) and/or the insert modules (9) are embodied extending over a total length of more than 30%, in particular more than 40%, particularly preferably more than 50% of the coil width.

4.-5. (canceled)

6. The transport and storage system according to claim 1, characterized in that the base module (8) is made of a different corrugated cardboard quality, in particular a higher corrugated cardboard quality, than the insert module (9) and/or that the corrugated cardboard for forming the modules (8, 9), or the stacks of corrugated cardboard, or the corrugated cardboard and the stacks formed therefrom are glued together in a waterproof manner wherein the liners (1, 4, 6) and the corrugated layers (2, 5) are glued in a moisture-resistant and in particular waterproof manner and/or the corrugated cardboard layers are combined to form corrugated cardboard stacks which are glued together over their entire surface by means of the liners (1, 3, 6) so that an at least two-flute, in particular more than three-flute, preferably more than ten-flute, and even more preferably more than twenty-flute composite or stack is formed and that the paper material forming the corrugated cardboard is equipped or bonded in a way that makes it moisture-resistant and/or fungicidal, and/or the material for the liners (1, 4, 6) of the corrugated cardboard is a kraft liner and/or the corrugated webs (2, 5) are made of semichemical pulp or bogus paper.

7.-12. (canceled)

13. The transport and storage system according to claim 1, characterized in that the base module (8) is embodied as U-shaped in cross-section, with a bottom wall (15) and two side walls (16) extending orthogonal therefrom.

14. The transport and storage system according to claim 1, characterized in that orthogonal to the cross-section, the base module (8) has a length that corresponds to the length of a coil to be received or that is shorter or longer than it, or the base module (8) has the basic dimensions of a standard pallet, i.e. is 800×1200 mm in size.

15. The transport and storage system according to claim 1, characterized in that on the underside in the bottom wall (15), the base module (8) has openings for being engaged by forklifts or for a tongue-and-groove system to allow the base modules (8) to be stacked on top of one another by means of their bottom walls.

16. The transport and storage system according to claim 1, characterized in that in order to contain a coil on all sides, the arrangement composed of a base module (8) and at least one insert module (9) is conversely placed onto the coil from above, wherein the base modules (8) rest against one another with end surfaces (20) of their side walls (16) or are spaced apart from one another by 1 mm to 100 mm, in particular 5 mm to 25 mm.

17. The transport and storage system according to claim 1, characterized in that the base module (8) has tongues and grooves on end surfaces (20) of the side walls (16) in order for it and an identically embodied base module (8) to reciprocally fit into each other when their end surfaces (20) rest against each other.

18. The transport and storage system according to claim 1, characterized in that the insert module (9) is embodied as triangular in cross-section, with a flat receiving surface (11) or conversely has a cut out region that is triangular in cross-section, forming two receiving surfaces (11), wherein the opening of the triangular cut-out faces upward and is wider than the diameter of a coil, wherein at least two insert modules (9) are provided, which are embodied as triangles in cross-section and in particular as regular right triangles in which the triangle legs define a right angle with each other and that two insert modules (9) are positioned opposite each other, wherein one leg (17) rests with its contact surface (10) on a bottom wall (15) of the base module (8) and a vertical leg (18) rests with its contact surface (10) against a side wall (16) of the base module (8).

19.-20. (canceled)

21. The transport and storage system according to claim 1, characterized in that in order to fill a distance between the base module (8) and a transport container wall, modules are positioned between the base module (8) and a transport container wall.

22. The transport and storage system according to claim 1, characterized in that at least one insert module (9) is provided, wherein the at least one insert module (9) has at least one receiving surface (11) that is concave or elliptically curved and in particular, is embodied as a cylinder circumference segment and that the insert module (9) has a width that corresponds to the inner width between the side walls (16) of the base module (8) so that the base module (8) is able to receive the insert module (9) with a positive fit wherein the size of the triangular insert modules (9) or the radius of the concave receiving surface (11) is adapted to the diameter of a coil that is to be received or the elliptical curvature of the receiving surface (11) is adapted so that it deviates from the outer radius of the coil by at most 100 mm, in particular by at most of 50 mm.

23.-24. (canceled)

25. The transport and storage system according to claim 1, characterized in that at least one cylindrical element extends away from a receiving surface (11), toward a contact surface (10), and through the insert module (9) or through the insert module (9) and the base module (8).

26. The transport and storage system according to claim 1, characterized in that the at least one cylindrical element is mounted in a bore with a positive fit or interference fit wherein the bore extends radially outward in relation to the radius of a coil to be received or extends outward at an angle to the radial direction.

27. (canceled)

28. The transport and storage system according to claim 1, characterized in that the cylindrical element is embodied as a solid cylinder or hollow cylinder.

29. The transport and storage system according to claim 1, characterized in that the cylindrical element is made of metal, plastic, or cardboard.

30. The transport and storage system according to claim 1, characterized in that the cylindrical element extends through the bore and terminates with a positive fit with the respective surfaces of the insert module (9), or the cylindrical element is recessed by 1 mm to 100 mm, in particular 2 to 50 mm, preferably 2 to 20 mm, in the region of the receiving surface (11) and is spaced apart from the receiving surface (11) by means of a cavity.

31. The transport and storage system according to claim 1, characterized in that the cylindrical element contacts a bottom wall of a container or a load-bearing beam of an entire transport arrangement.

32. The transport and storage system according to claim 1, characterized in that several bores and several cylindrical elements distributed around the circumference or along a receiving surface (11) extend through the insert module (9) or through the insert module (9) and the base module (8).

33. A use of a transport and storage system according to claim 1 for rail, truck, or maritime transport or for storage of metal coils in a building.
